(19) United States
(12) Patent Application Publication
(10) Pub. No.: US 2007/0164574 A1
(43) Pub. Date: Jul. 19, 2007

(54) Collision obstacle discrimination device

(75) Inventor: Takatoshi Tanabe, Ichinomiya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/653,623

(22) Filed: Jan. 15, 2007

(30) Foreign Application Priority Data
Jan. 17, 2006 (JP) 2006-008858

(51) Int. Cl. B60R 19/02

(52) U.S. Cl. 293/102

(57) ABSTRACT

A collision obstacle discrimination device has a load sensor. The load sensor includes an elongated member which is arranged in a bumper of a vehicle and extends substantially in a width direction of the vehicle, and a plurality of sensor members which are fixed in a space defined by the elongated member and arrayed in the vehicle width direction. The sensor member is disposed to detect a physical property which varies in response to a load applied to the bumper due to a collision of the vehicle. Sensitivities of the plurality of sensor members are respectively set in response to vehicle-width-direction positions of the sensor members to be diversified, so that the plurality of sensor members have a substantially same response property with respect to the load applied to the bumper.

### CROSS REFERENCE TO RELATED APPLICATION

This application is based on a Japanese Patent Application No. 2006-8858 filed on Jan. 17, 2006, the disclosure of which is incorporated herein by reference.

### FIELD OF THE INVENTION

The present invention relates to a collision obstacle discrimination device which can be suitably used for a vehicle to sort-discriminate an obstacle colliding with the vehicle.

### BACKGROUND OF THE INVENTION

Generally, it is desirable to protect a pedestrian from a collision with a vehicle. Therefore, various pedestrian protecting devices are proposed. However, various adverse effects will be caused in the case where the pedestrian protecting device is actuated despite the obstacle is not the pedestrian. Accordingly, it is necessary to determine whether or not the collision obstacle is a pedestrian.

For example, as disclosed in JP-11-310095A, the discrimination of the pedestrian is performed, based on the increase rate of a collision load after the collision load exceeds a predetermined value.

In this case, when a load sensor has the different sensitivities in response to the different collision occurrence portions (at vehicle) in the vehicle width direction, it is difficult to determine that the obstacles colliding with different parts of the vehicle are of the same sort despite the obstacles are of the same sort.

Therefore, with reference to WO-2004-033261A, it is sought to homogenize the sensitivity property of the load sensor (of device which detects collision due to obstacle based on load variation) with respect to the different parts of the load sensor in the vehicle width direction.

However, as disclosed in WO-2004-033261A, a complicated construction is used to locally change the transference of the impact (due to collision) with respect to the each part of the load sensor. Thus, a simplification is required.

### SUMMARY OF THE INVENTION

In view of the above-described disadvantage, it is an object of the present invention to provide a collision obstacle discrimination device, which substantially sort-discriminates an collision obstacle with respect to different collision occurrence positions of a vehicle and has a simplified construction.

According to the present invention, a collision obstacle discrimination device has an elongated member which is arranged in a bumper of a vehicle and extends substantially in a width direction of the vehicle, and a plurality of sensor members which are fixed in a space defined by the elongated member and arrayed in the vehicle width direction. The sensor member is disposed to detect a physical property which varies in response to a load applied to the bumper due to a collision of the vehicle. Sensitivities of the plurality of sensor members are respectively set in response to vehicle-width-direction positions of the sensor members to be diversified, so that the plurality of sensor members have a substantially same response property with respect to the load applied to the bumper.

Because the multiple sensor members which have the different detection sensitivities are fixed to the elongated member in the vehicle width direction, the construction and the mounting of the collision obstacle discrimination device can be simplified. Moreover, because the plurality of sensor members have a substantially same response property with respect to the load applied to the bumper, the subsequent process can become easy.

Preferably, each of the sensor members is mounted to an inner surface of the elongated member, and has a spacer and a load detection unit which detects the physical property. The spacers of the plurality of sensor members partition the space defined by the elongated member into a plurality of gaps, in each of which the load detection unit of the corresponding sensor member is arranged.

More preferably, the elongated member includes a first band-shaped portion and a second band-shaped portion which are opposite to each other. The plurality of sensor members are sandwiched between the first band-shaped portion and the second band-shaped portion.

More preferably, the load detection unit includes a first contact portion, and a second contact portion which has a pressure sensitive ink. The first contact portion and the second contact portion face each other with the gap being arranged therebetween. A resistance between the first contact portion and the second contact portion varies in response to a pressure applied to the load detection unit.

Thus, the sensitivity (i.e., amplitude of pressure which can be detected) of the sensor member can be readily adjusted by an alteration of the composition and the like of the pressure sensitive ink.

### BRIEF DESCRIPTION OF THE DRAWINGS

Other objects, features and advantages of the present invention will become more apparent from the following detailed description made with reference to the accompanying drawings, in which:

FIG. 1 is a partially longitudinally sectional view showing a front portion of a vehicle where a collision obstacle discrimination device is mounted according to a first embodiment of the present invention;

FIG. 2 is a partially laterally sectional view showing the front portion of the vehicle in FIG. 1;

FIG. 3 is a partially cross-sectional view showing a load sensor according to the first embodiment;

FIG. 4 is a front view showing a spacer of the load sensor according to the first embodiment;

FIG. 5 is a graph showing a relation between a load and a deformation amount of a middle portion of a bumper and a relation between a load and a deformation amount of an end portion of the bumper according to the first embodiment;

FIG. 6 is a partially cross-sectional view showing a load sensor according to a first modification of the first embodiment;

FIG. 7 is a schematic view showing wirings of the load sensor according to the first embodiment;

FIG. 8A is a schematic perspective view showing a sensor member which is independently constructed according to a second modification of the first embodiment, and FIG. 8B is a schematic disassembled view showing the sensor member in FIG. 8A; and

FIG. 9 is a partially laterally sectional view showing a collision obstacle discrimination device according to a second embodiment of the present invention.

### DETAILED DESCRIPTION OF THE EXAMPLED EMBODIMENTS

### First Embodiment

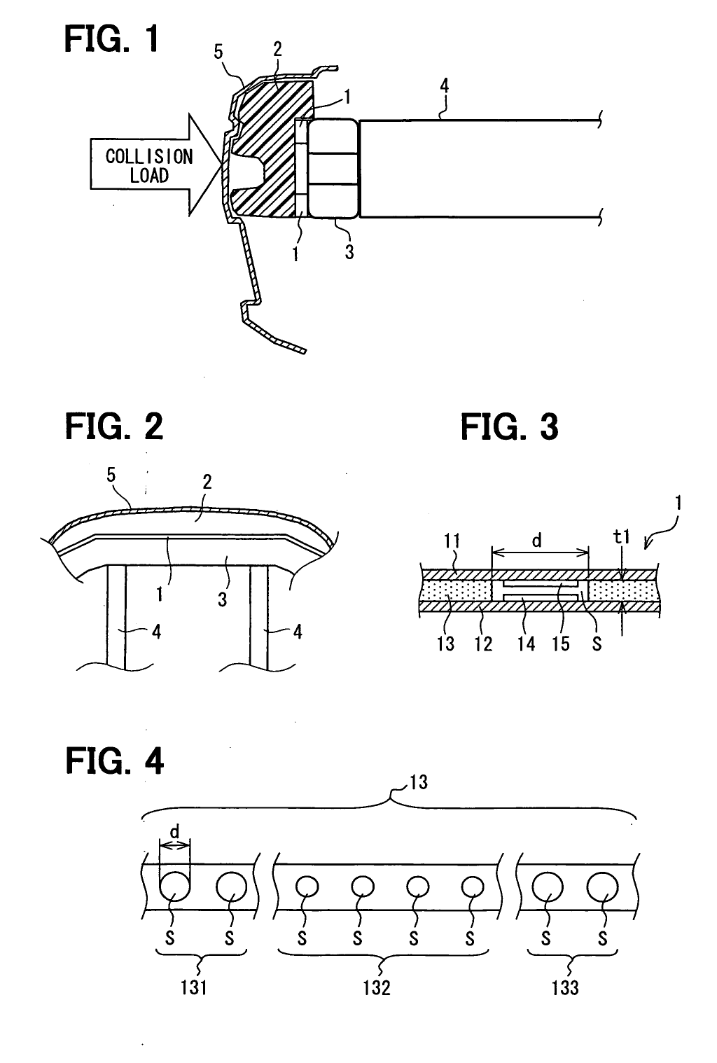

A collision obstacle discrimination device according to a first embodiment of the present invention will be described with reference to FIGS. 1-8B. The collision obstacle discrimination device can be suitably used for a vehicle, for example. In this case, the collision obstacle discrimination device can be arranged at a front portion of the vehicle, for example, at a front side of an engine cabin of the vehicle. As shown in FIGS. 1 and 2, the collision obstacle discrimination device has at least one load sensor 1 and a calculation unit (not shown).

A bumper of the vehicle is provided with a bumper absorber 2, which is arranged in a bumper cover 5 and extends in the vehicle width direction to absorb a collision energy (i.e., buffer impact) in the case of a collision of the vehicle. The bumper absorber 2 can be constructed of a foam material, for example.

In this case, the two load sensors 1, which are positioned in the bumper, are sandwiched between the bumper absorber 2 and a reinforcement member 3 of the vehicle, and extend substantially in the vehicle width direction. One of the load sensors 1 is positioned at the upper side of the other. That is, the two load sensors 1 are arrayed in the vehicle up-down direction. The reinforcement member 3 is fixed to front ends of side members 4 of the vehicle to reinforce the vehicle bumper.

As shown in FIG. 3, the load sensor 1 has multiple sensor members, and an elongated member which includes a first band-shaped portion 11 and a second band-shaped portion 12. Each of the sensor members has a first contact portion 15 and a second contact portion 14. The first band-shaped portion 11 and the second band-shaped portion 12 have a substantially band shape, and sandwich therebetween a spacer 13. Moreover, the first contact portions 15 and the second contact portions 14 are respectively fixed to the inner surfaces of the first band-shaped portion 11 and the second band-shaped portion 12.

The length of the first band-shaped portion 11 and the second band-shaped portion 12 can be determined corresponding to the length of the part of the vehicle where a load (due to collision or the like) is to be detected. For example, the length of the first band-shaped portion 11 and the second band-shaped portion 12 can be set substantially same with the width of the bumper, to detect the load applied at the bumper over the whole width direction of the bumper (vehicle). Therefore, the width of the first band-shaped portion 11 and the second band-shaped portion 12 is determined by the dimensions of the second contact portions 14, the first contact portions 15 and the spacer 13.

It is desirable to provide a pressure-sensitive ink for at least one of the second contact portion 14 and the first contact portion 15 (which construct load detection unit). By a combination of the pressure-sensitive ink with the contact portion 14, 15, the electrical resistance between the contact portion 14 and 15 can vary in response to a pressure applied to the contact portion 14, 15. In addition to the pressure-sensitive ink, an electrically conductive material (e.g., carbon or metal such as silver) can be also combined, or be singly used.

Alternatively, even without using the pressure sensitive ink, a load which is larger than a predetermined value can be detected if the contact between the second contact portion 14 and the first contact portion 15 is detected.

More alternatively, the load detection can be also performed by measuring an electrical capacitance, or an electromotive force or the like, in addition to the resistance variation. For example, a dielectric can be sandwiched between the second contact portion 14 and the first contact portion 15. In this case, the load exerted between the second contact portion 14 and the first contact portion 15 can be detected by measuring the electrical capacitance. Instead of the dielectric, a piezoelectric material can be also sandwiched between the second contact portion 14 and the first contact portion 15, so that the load applied to the contact portions 14 and 15 can be directly detected as a voltage variation (electromotive force).

In this embodiment, the measurement method of the variation of the resistance and the like are not limited. In this case, the variation of the resistance and the like can be detected by a general method, for example, by directly detecting the voltage variation, or by providing an oscillation circuit and detecting an oscillation frequency of the oscillation circuit.

The load applied to the load sensor 1 (i.e., deformation of load sensor 1) can be regulated by the spacer 13. That is, the load detected by the load sensor 1 varies in response to the dimension of a space S (gap), which is defined by the spacer 13 and positioned between the first band-shaped portion 11 and the second band-shaped portion 12. That is, when the dimension d (which is dimension in longitudinal direction of band-shaped portion 11, 12) of the space S of the sensor member becomes large, the deformation of the spacer 13 (space S) increases even when a small exterior load is applied to the sensor member. Thus, the detection load (i.e., output signal) of the load sensor 1 becomes relatively large.

In this case, the material which constructs the spacer 13 is not limited. For example, the spacer 13 can be constructed of a thin plate made of a plastic, or a metal or the like. Alternatively, the spacer 13 can be also constructed of an elastic material such as a rubber or a foam material or the like.

According to this embodiment, as shown in FIG. 4, the load sensor 1 can be provided with the spacer 13 which is substantially plate-shaped to be an integral member (i.e., one-piece member). In this case, the spacer 13 is provided therein with the multiple spaces S (through holes) which are arranged to correspond to the positions of the sensor members. That is, the spacer portion of (of spacer 13) the each sensor member defines therein the space S.

The multiple spaces S can have a substantially cylindrical shape and have different diameters d. That is, the space between the band-shaped portions 11 and 12 are partitioned by the spacer 13 into the multiple gaps S.

Alternatively, as described later, the load sensor 1 can be also provided with the multiple spacer portions which are separate from each other and respectively provided for the sensor members.

As shown in FIGS. 3 and 4, the detection sensitivity of the sensor member can be adjusted, by altering the diameter d of the space S. That is, with the diameter d becoming large, the stress necessary for making the second contact portion 14 and the first contact portion 15 approach each other becomes small. Therefore, the detection load (output signal) of the sensor member having the second contact portion 14 and the first contact portion 15 can be increased even when the exterior force is relatively small. Accordingly, with the increase of the diameter d, the sensitivity of the corresponding sensor member can be heightened.

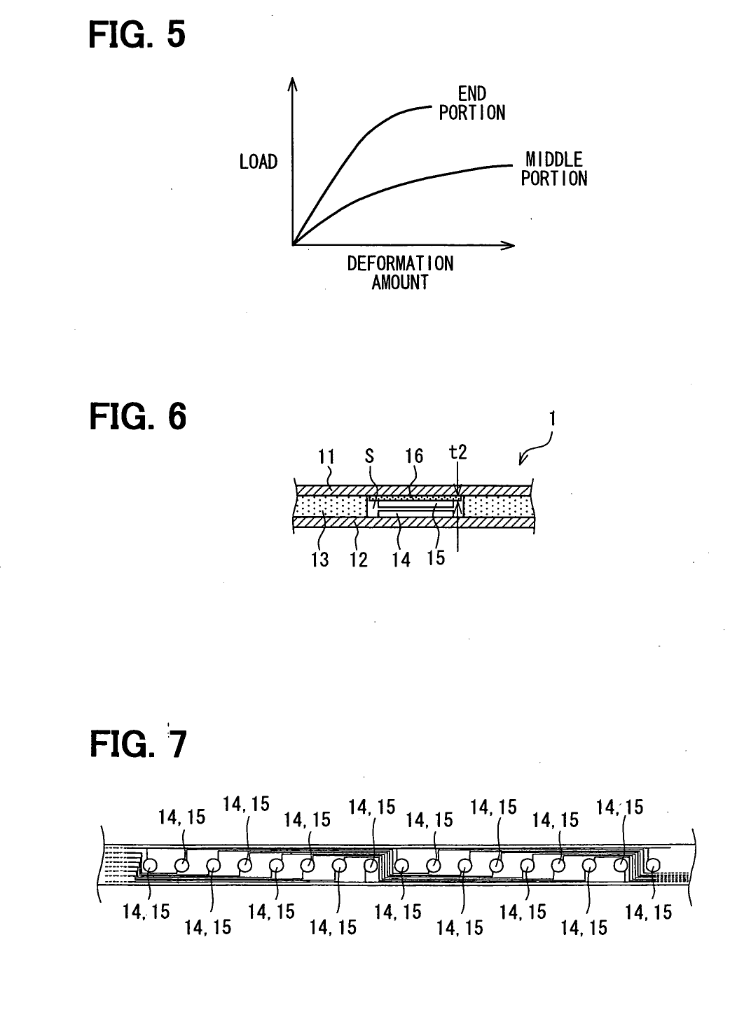

For example, in the case where the bumper has a substantially flat shape in the width-direction middle portion thereof and has a large curvature at the width-direction end portion thereof (that is, bumper has a general shape), the stiffness of the bumper in the vicinity of the end portions thereof is relatively high. Thus, as shown in FIG. 5, the deformation amount of the bumper in the vicinity of the end portion thereof is smaller than that in the vicinity of the middle portion thereof, even when the same force is exerted thereat.

According to this embodiment, as shown in FIG. 4, the spaces S (defined by spacer portions 131 and 133 of spacer 13) of the sensor members which are positioned in the vicinity of the two end portions of the bumper are provided with the larger diameter d, than the spaces S (defined by spacer portion 132 of spacer 13) of the sensor members positioned in the vicinity of the middle portion of the bumper.

Thus, the sensor member positioned at the end portion of the bumper can be deformed due to a smaller load, than the sensor member positioned at the middle portion does. Therefore, the variation in the deformation amounts of the sensor members positioned at the different parts of the bumper can be reduced.

Moreover, the detection sensitivity of the sensor member can be also adjusted by altering the thickness of the spacer 13, in addition to the alteration of the diameter d of the space S (defined by spacer 13) of the sensor member. With a decrease of the thickness of the spacer 13 of the sensor member, the amplitude of output (i.e., detection load) of the second contact portion 14 and the first contact portion 15 of the sensor member can be increased while a small load is exerted to the sensor member.

In the case where it is difficult to adjust the thickness of the spacer 13 for each of the sensor members (which are respectively positioned at different vehicle-width-direction positions), the load applied between the second contact portion 14 and the first contact portion 15 of the sensor member can be adjusted by arranging a second spacer 16 at one of a surface (at the side of band portion 12) of the second contact portion 14 and a surface (at the side of band portion 11) of the first contact portion 15, as shown in 6 (where second spacer 16 is arranged at the surface of first contact portion 15).

The multiple second spacers 16 can be respectively provided for the different sensor members, and separate from each other. Thus, the detection sensitivity of each of the sensor members can be adjusted, by altering the thickness t2 of the second spacer 16. In this case, these surfaces of the first contact portion 15 and the contact portion 14 are opposite to each other.

Similarly to the case of the adjustment of the thickness of the spacer 13, with the increase of the thickness t2 of the second spacer 16, the load detected by the second contact portion 14 and the first contact portion 15 becomes large. Thus, the detection sensitivity of the sensor member is improved.

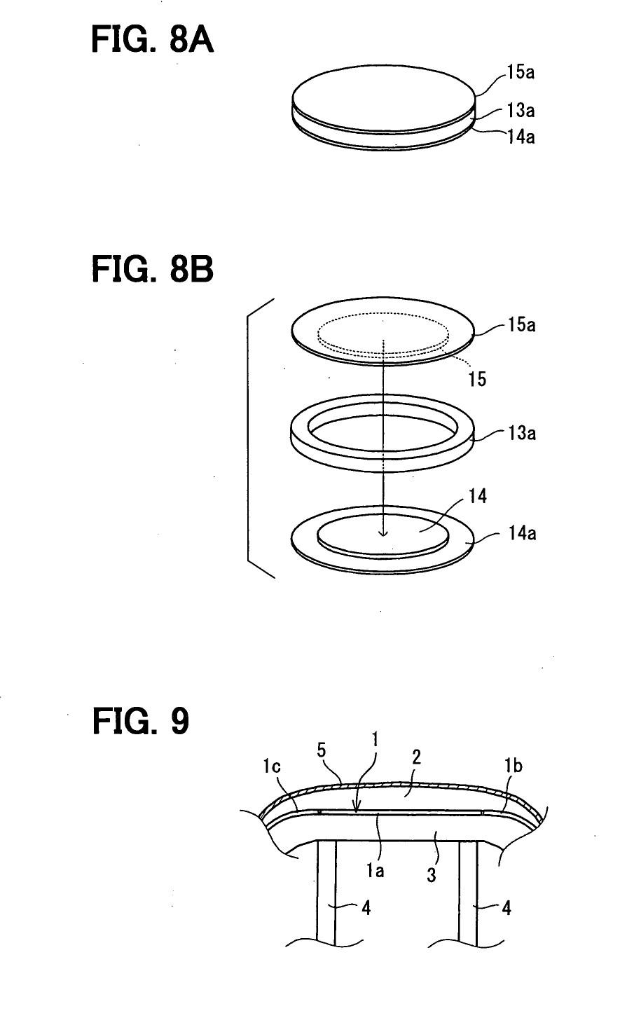

As described above, the spacer 13 of the load sensor can be provided with the integral shape (i.e., continuous shape) to have a substantially same longitudinal-direction dimension with those of the first band-shaped portion 11 and the second band-shaped portion 12. Alternatively, with reference to FIGS. 8A and 8B, the sensor member can be constructed of the second contact portion 14 and the first contact portion 15 which sandwich a spacer portion 13a therebetween. The multiple spacer portions 13a are separate from each other, and can be respectively provided for the sensor members of the load sensor 1.

In this case, for example, the spacer 13a of the sensor member can contact the second contact portion 14 at a rim portion 14a of the second contact portion 14, and contact the first contact portion 15 at a rim portion 15a of the first contact portion 15.

As shown in FIG. 7, the sensor members of the load sensor 1 can be respectively provided with the wirings which are independent of each other, so that the resistance between the second contact portion 14 and the first contact portion 15 of the each of the sensor members can be measured. Thus, the load applied to the each sensor member can be detected.

Alternatively, other wiring method for the sensor members of the load sensor 1 can be also used. For example, all of the sensor members can be divided into multiple groups (or all of sensor members are regarded as one group), and the sensor members of the each group collectively detect the load applied to these sensor members. In this case, the sensor members of the each group can be connected in parallel or in series, to collectively detect the load. By detecting the resistance of the sensor members of the each group which are connected together, the load applied to the sensor members of the each group can be collectively calculated.

The calculation unit is provided to determine the variation of the physical quantity (physical property) such as the resistance and the like (as described above) at the sensor members, and sort-discriminate an obstacle colliding with the vehicle based on the variation of the physical quantity.

Next, the sort-discrimination operation of the collision obstacle discrimination device according to this embodiment will be described.

When there occurs a collision between the vehicle (e.g., bumper positioned at vehicle front portion) and the obstacle (e.g., pedestrian or other object such as vehicle which has a larger mass than pedestrian), the collision load is exerted to the vehicle. Thus, stress in a compress direction (with respect to vehicle traveling direction, for example) is generated in the vehicle. The stress can be sequentially exerted to the bumper cover 5, the bumper absorber 2, the load sensor 1, the bumper reinforcement member 3 and the side member 4, when being viewed from the vehicle side. In this case, each of the side member 4 and the bumper reinforcement member 3 can be provided with a relatively high stiffness. Thus, the stress exerted to the bumper reinforcement member 3 is substantially equal to that applied to the load sensor 1 which is arranged at the front surface of the bumper reinforcement member 3.

In this case, the load from the exterior is applied to the load sensor 1 to compress the load sensor 1. Thus, the part of the spacer 13 (which is positioned in the vicinity of collision occurrence part of the vehicle) and the spaces S defined in the part of the spacer 13 are deformed. Therefore, the load applied between the second contact portion 14 and the first contact portion 15 of the sensor member increases. Thus, as described above, the physical quantity (e.g., resistance) at the contact portion 14, 15 of the sensor member varies.

According to this embodiment, the diameter d of the space S and the contact area between the second contact portion 14 and the first contact portion 15 of the sensor member is adjusted (set) in response to the arrangement position where the sensor member is mounted to the bumper, so that the variations of the physical quantities occurring at the different sensor members are substantially homogenized in the case where the load (from obstacle colliding with vehicle) applied to the different sensor members is substantially same. That is, the detection loads of the sensor members mounted to the different vehicle-width-direction positions are substantially homogenized, with respect to the same exterior force.

Therefore, whichever position of the bumper the collision with the obstacle occurs at, the sensor member in the vicinity of the collision occurrence position can output the signal having the substantially same level if the load exerted to the bumper due to the collision is substantially same (i.e., collision obstacle is of substantially same degree).

Accordingly, the output signal from the sensor member can be used for the sort-discrimination of the obstacle, without being corrected in response to the mounting position of the sensor member at the bumper.

According to this embodiment, the load (pressure) exerted to the bumper is calculated based on the output signals of the sensor members of the load sensor 1, and the obstacle is sort-discriminated according to the pressure value. For example, the integration of the load applied to the bumper is calculated with respect to the time how long the load is applied, and the integration value is divided by the vehicle velocity (detected by a vehicle velocity sensor which is not shown) immediately before the collision occurrence so that the mass of the obstacle colliding with the bumper is calculated.

When the calculated mass is within a pedestrian mass range (e.g., having mass of six-year-old child as lower limit and mass of adult as upper limit), it is determined that the collision obstacle is the pedestrian. Thus, an actuation signal is inputted into a pedestrian protecting device (not shown) so that the pedestrian protecting device is appropriately actuated. Therefore, the damage to the pedestrian colliding with the vehicle can be reduced. In this case, the pedestrian protecting device is not limited, and can be provided with an airbag which can be deployed on a vehicle hood, and/or a hood raising device for lifting the vehicle hood in the collision, or the like.

According to this embodiment, the detection sensitivity of the sensor member with respect to the load applied thereto is adjusted in response to the arrangement position of the sensor member at the bumper of the vehicle (that is, sensitivities of sensor members of load sensor 1 are diversified). Thus, it is unnecessary to perform a subsequent process such as the correction by the calculation unit. Therefore, the collision obstacle discrimination device can be simplified.

### Second Embodiment

According to a second embodiment of the present invention, with reference to FIG. 9, the collision obstacle discrimination device can be provided with the load sensor 1 which includes multiple chamber type load sensor members (e.g., three chamber type load sensor members 1a, 1b and 1c).

In the second embodiment, each of the chamber type load sensor members 1a, 1b and 1c includes a chamber which is closed and provided with gas such as air therein, and a pressure detection unit which can be arranged in the chamber to detect a pressure in the chamber. That is, the elongated member of the load sensor 1 defines therein the chambers which are respectively closed (i.e., independent of each other) and sequentially arrayed in the vehicle width direction. In this case, the spacer 13 is not used.

As described above, the collision load applied to the bumper is more easily transferred to the sensor member which is arranged in the vicinity of the middle portion of the bumper than that arranged in the vicinity of the end portion of the bumper. That is, even when the same load is applied to the middle portion and the end portion of the bumper, the sensor member in the vicinity of the middle portion is more easily deformed than that in the vicinity of the end portion.

According to the second embodiment, the pressure in the chamber of the chamber type load sensor member 1b and that in the chamber of the chamber type load sensor member 1c which are respectively arranged in the vicinity of the two end portions of the bumper can be increased, than the pressure in the chamber of the chamber type load sensor member 1a arranged in the vicinity of the middle portion of the bumper.

That is, even when the sensor member 1a has a same deformation with that of the sensor member 1b, 1c, the output signal of the pressure in the chamber of the sensor member 1b, 1c is set larger than the output signal of the pressure in the chamber of the sensor member 1a.

Thus, by setting a ratio between the inner pressure of the sensor member 1a and that of the sensor member 1b, 1c in response to a relative ratio between the deformation of the sensor member 1a and that of the sensor member 1b, 1c, the sensor member 1b, 1c can output a substantially same pressure value (pressure signal) with that of the sensor member 1a even when the sensor member 1b, 1c has a different deformation amount from that of the sensor member 1a due to the same collision load. That is, the detection sensitivity of the sensor members which are mounted to the different positions of the bumper can be substantially homogenized.

About the collision obstacle discrimination device, what has not described in the second embodiment is the same with the first embodiment.

### Third Embodiment

According to a third embodiment of the present invention, the load sensor 1 of the collision obstacle discrimination device is constructed of a tube type load sensor (not shown). The tube type load sensor 1 has a tube (elongated member). One end of the tube of the tube type load sensor 1 is blocked, and the inner pressure is detected at the other end thereof. The tube type load sensor 1 is mounted to the bumper, and extends to the substantially whole bumper in the vehicle width direction. In this case, the spacer 13 is not used.

As described above, the bumper has different deformation (due to collision load, for example) at the different part thereof. According to the third embodiment, the different parts of the tube can be provided with the different stiffness. For example, in the case where the same load is applied, the part (of the tube) which has a small deformation due to the load can be provided with a low stiffness, and the part (of the tube) which has a large deformation can be provided with a high stiffness.

The stiffness of the tube can be adjusted via the thickness of the tube (i.e., tube provided with a larger thickness has a higher stiffness), the material of the tube, the diameter of the tube, and the like. Moreover, the length of the tube in the compression direction thereof due to the collision load can be increased, so that a relatively large pressure variation can be caused in the tube even when the deformation amount of the tube is same.

About the collision obstacle discrimination device, what has not described in the third embodiment is the same with the first embodiment.

What is claimed is:

1. A collision obstacle discrimination device, comprising
a load sensor which includes:
an elongated member which is arranged in a bumper of a vehicle and extends substantially in a width direction of the vehicle, the elongated member defining therein a space; and
a plurality of sensor members which are fixed in the space of the elongated member and arrayed in the vehicle width direction, the sensor member being disposed to detect a physical property which varies in response to a load applied to the bumper due to a collision of the vehicle, wherein
sensitivities of the plurality of sensor members are respectively set in response to vehicle-width-direction positions of the sensor members to be diversified, so that the plurality of sensor members have a substantially same response property with respect to the load applied to the bumper.

2. The collision obstacle discrimination device according to claim 1, wherein
each of the sensor members is mounted to an inner surface of the elongated member, and has a spacer portion and a load detection unit which detects the physical property,
the spacer portions of the plurality of sensor members partitioning the space defined by the elongated member into a plurality of gaps, in each of which the load detection unit of the corresponding sensor member is arranged.

3. The collision obstacle discrimination device according to claim 2, wherein
the elongated member includes a first band-shaped portion and a second band-shaped portion which are opposite to each other; and
the plurality of sensor members are sandwiched between the first band-shaped portion and the second band-shaped portion.

4. The collision obstacle discrimination device according to claim 2, wherein
the load detection unit includes a first contact portion, and a second contact portion which has a pressure sensitive ink,
the first contact portion and the second contact portion facing each other and being spaced from each other by the gap,
a resistance between the first contact portion and the second contact portion varying in response to a pressure applied to the load detection unit.

5. The collision obstacle discrimination device according to claim 4, wherein
the sensitivities of the plurality of sensor members are diversified in response to the vehicle-width-direction positions of the sensor members, by diversifying kinds of the pressure sensitive inks.

6. The collision obstacle discrimination device according to claim 2, wherein
the sensitivities of the plurality of sensor members are diversified in response to the vehicle-width-direction positions of the sensor members, by adjusting a deformation amount of the sensor member via an alteration of at least one of a thickness of the spacer portion, an elasticity of the spacer portion, and a dimension of the gap partitioned by the spacer portion.

7. The collision obstacle discrimination device according to claim 1, wherein
the load sensor is sandwiched between a bumper absorber of the vehicle and a bumper reinforcement member of the vehicle,
the bumper absorber extending in the vehicle width direction in the bumper to buffer an impact to the vehicle due to the collision,
the bumper reinforcement member being arranged at a vehicle rear side of the bumper absorber and extending along the bumper absorber.

8. The collision obstacle discrimination device according to claim 2, wherein
the spacer portions of the plurality of sensor members are integrated with each other.

9. The collision obstacle discrimination device according to claim 1, wherein
the load sensor is a chamber type load sensor,
the elongated member defining therein a plurality of chambers which are respectively closed,
the sensor members respectively detecting pressures in the chambers, the pressure varying in response to the load applied to the bumper due to the collision.

10. The collision obstacle discrimination device according to claim 9, wherein
the sensitivities of the plurality of sensor members are diversified in response to the vehicle-width-direction mounting positions of the sensor members, by adjusting the pressure in the chamber.

11. The collision obstacle discrimination device according to claim 1, wherein the load sensor is a tube type load sensor.
